(19) United States
(12) Patent Application Publication
(10) Pub. No.: US 2026/0145536 A1
(43) Pub. Date: May 28, 2026

(54) Measuring device comprising a transformer and piezoelectric elements for a motor vehicle

(71) Applicant: Continental Automotive Technologies GmbH, Hannover (DE)

(72) Inventors: Thomas MORIN, Toulouse (FR); Thierry CHAUCHARD, Pechbonnieu (FR); Kahina TELMAT, Toulouse (FR)

(73) Assignee: Continental Automotive Technologies GmbH, Hannover (DE)

(21) Appl. No.: 19/356,542

(22) Filed: Oct. 13, 2025

(30) Foreign Application Priority Data
Nov. 22, 2024 (FR) FR2412836

(51) Int. Cl. B60L 3/00; B60L 50/64; H02K 11/35

(52) U.S. Cl. CPC B60L 3/0061; B60L 50/64; H02K 11/35

(57) ABSTRACT

A device for a parameter for a motor vehicle, including a main module and a remote module. The main module includes a control stage and a primary winding. The control stage being configured to electrically power the primary winding on the basis of an alternating current so that the primary winding generates a variable magnetic field which is a function of the alternating current. The remote module includes a secondary winding, immersed in the magnetic field when the magnetic field is generated. An external piezoelectric transceiver is connected to the secondary winding in a wired manner and configured to transmit and receive ultrasonic signals. An internal piezoelectric transceiver is configured to transmit and receive ultrasonic signals, and a sensitive element is configured to measure the parameter.

### CROSS REFERENCE TO RELATED APPLICATION

This application claims priority to French Application No. FR2412836, filed Nov. 22, 2024, the contents of such application being incorporated by reference herein.

### FIELD OF THE INVENTION

The present invention relates to the field of motor vehicles and more particularly concerns a measuring device comprising a transformer and piezoelectric elements for a motor vehicle and its method of implementation.

### BACKGROUND OF THE INVENTION

In a known manner, an electric motor contains a rotor and a stator. The operation of such a motor causes heating of the rotor and the stator. However, the rise in temperature of the rotor may cause loss of performance and demagnetization of the magnets placed inside beyond a certain temperature, this possibly resulting in damage to or even failure of the motor. It is therefore necessary to measure the temperature inside the rotor so as to be able to reduce the speed of the latter when the temperature approaches the critical operating limit and thus avoid damaging the motor or else failure thereof.

Due to its rotation during its operation, the temperature of the rotor is difficult to measure directly by wired temperature sensors; it is therefore estimated by algorithms and models integrated into the management system of the motor.

However, these integrated models and algorithms cause measurement errors which may reach plus or minus 20° C., this not being satisfactory for controlling the motor in order to avoid damaging it or causing failure thereof.

A simple, reliable and efficient solution allowing these drawbacks to be at least partly overcome would therefore be advantageous.

### SUMMARY OF THE INVENTION

To this end, an aspect of the invention is firstly a device for measuring a parameter for a motor vehicle, said device comprising a main module and a remote module, said main module comprising a control stage and a primary winding, said control stage being configured to electrically power the primary winding on the basis of an alternating current so that said primary winding generates a variable magnetic field which is a function of said alternating current, said remote module comprising a secondary winding, immersed in said magnetic field when said magnetic field is generated, an external piezoelectric transceiver connected to said secondary winding in a wired manner and configured to transmit and receive ultrasonic signals, an internal piezoelectric transceiver configured to transmit and receive ultrasonic signals, and a sensitive element configured to measure said parameter, to generate a measurement signal comprising at least one value of the measured parameter and to transmit said measurement signal to said internal piezoelectric transceiver, said secondary winding being configured to generate an alternating electric current on the basis of variations in the magnetic field generated by the primary winding and to transmit said electric current to the external piezoelectric transceiver in order to electrically power it, the external piezoelectric transceiver being configured to, when it is electrically powered by the electric current received from the secondary winding, transmit ultrasonic signals to the internal piezoelectric transceiver, said internal piezoelectric transceiver being configured to collect energy from the ultrasonic signals received from the external piezoelectric transceiver, to electrically power the sensitive element using said energy, to receive a measurement signal generated by the sensitive element, to extract the at least one value of the measured parameter from said received measurement signal and to command the transmission of ultrasonic signals containing the at least one extracted parameter value to the external piezoelectric transceiver, the external piezoelectric transceiver being configured to generate and transmit an alternating current signal containing the at least one extracted measured value to the secondary winding, the secondary winding being configured to generate a magnetic field when said secondary winding is powered by said alternating current signal, said magnetic field being detected by the primary winding, the control stage being configured to determine the at least one measured parameter value on the basis of the variations in the magnetic field which are detected by the primary winding.

The primary winding and the secondary winding form a transformer. Electrical energy, control commands and measured values are transmitted between the primary winding and the secondary winding by electromagnetic coupling. The secondary winding is controlled by the field received from the primary winding. The level received depends on the coupling factor which is itself dependent on the air gap and on the transformation ratio (number of secondary turns/number of primary turns) which may be adapted according to the intended application or the arrangement of the device in the vehicle.

The device according to an aspect of the invention makes it possible to carry out measurements at a distance via the remote module by powering the sensitive measuring element using energy from signals sent by the main module over a non-wired link. Thus, the measurements may be carried out as close as possible to the magnets, this increasing the performance of the control of the electric machine. An aspect of the invention furthermore makes it possible to dispense with metal barriers such as, for example, the casing and the protective flanges which may at least in part block electromagnetic waves of Wi-Fi or Bluetooth type.

In one embodiment, the internal piezoelectric transceiver is configured to store the energy from the ultrasonic signals received from the external piezoelectric transceiver.

According to one aspect of the invention, the sensitive element and the internal piezoelectric transceiver are connected in a wired or wireless manner.

In one embodiment, the remote module comprises an external communication stage configured to transmit signals containing the at least one measured value. The external communication stage may, for example, transmit using a communication protocol of Bluetooth or RFID type.

Advantageously, the external piezoelectric transceiver is configured to resonate at at least one predetermined frequency and the internal piezoelectric transceiver is configured to resonate at said at least one predetermined frequency.

An aspect of the invention also concerns an electric machine for a motor vehicle, said electric machine comprising a stator, a rotor and a measuring device as described above, said electric machine being configured to be mounted in said vehicle in order to drive the wheels of said vehicle in rotation, an electric machine in which the main module is mounted on the stator and the remote module is mounted on the rotor.

Advantageously, the rotor comprises a shaft containing a first shaft portion and a second shaft portion which are mounted on the stator by a system of bearings, the first shaft portion containing an end face extending orthogonally to the longitudinal axis of rotation of the rotor, the secondary winding is mounted on said end face, the external piezoelectric transceiver is mounted on the first shaft portion, the internal piezoelectric transceiver and the sensitive element are mounted inside the rotor and the primary winding is mounted on a portion of the stator facing said secondary winding.

An aspect of the invention also concerns a battery for a motor vehicle, comprising a measuring device as described above, the remote module being mounted such that the sensitive element is placed in said battery.

An aspect of the invention also concerns a battery pack for a motor vehicle, comprising a measuring device as described above, comprising at least one remote module mounted such that the sensitive element is placed in at least one of the batteries of the battery pack.

An aspect of the invention also concerns a fuel cell for a motor vehicle, comprising a measuring device as described above, the remote module being mounted such that the sensitive element is placed in said fuel cell.

An aspect of the invention also concerns a motor vehicle comprising a measuring device as described above.

In one embodiment, the vehicle is an electric or hybrid electric vehicle and comprises an electric machine as described above.

In one embodiment, the vehicle comprises a battery or a battery pack or a fuel cell as described above.

An aspect of the invention also concerns a method for measuring a parameter in a motor vehicle using a measuring device as described above, said method comprising the steps of:
electrical powering of the primary winding by the control stage with an alternating current,
generation, by the primary winding, of a variable magnetic field which is a function of said alternating current,
generation, by the secondary winding, of an alternating electric supply current on the basis of variations in the magnetic field generated by the primary winding,
transmission of said electric supply current by the secondary winding to the external piezoelectric transceiver,
transmission, by the external piezoelectric transceiver, of an ultrasonic supply signal,
reception, by the internal piezoelectric transceiver, of the transmitted ultrasonic supply signal,
electrical powering of the sensitive element by the internal piezoelectric transceiver with an electric current generated on the basis of the received ultrasonic supply signal so that said sensitive element carries out at least one measurement of the parameter,
measurement of the parameter by the sensitive element,
generation of a measurement signal by the sensitive element, said measurement signal containing at least one value of the measured parameter,
transmission, by the sensitive element, of the measurement signal to the internal transceiver,
reception, by the internal transceiver, of the measurement signal generated by the sensitive element,
conversion of the received measurement signal into an ultrasonic measurement signal,
transmission, by the internal transceiver, of said ultrasonic measurement signal,
reception, by the external piezoelectric transceiver, of the transmitted ultrasonic measurement signal,
conversion of the received ultrasonic measurement signal into an alternating excitation current signal containing the at least one value of the measured parameter,
powering of the secondary winding by said excitation current signal,
generation of a magnetic field by the secondary winding on the basis of said excitation current signal,
detection, by the primary winding, of variations in the magnetic field generated by the secondary winding,
determination, by the control stage, of the at least one measured parameter value on the basis of the variations in the magnetic field which are detected by the primary winding.

In one embodiment, the internal piezoelectric transceiver is configured to collect and store the electrical energy from the ultrasonic signals received from the external piezoelectric transceiver.

Advantageously, the energy from the received signals is stored until a predetermined threshold is reached before the sensitive element is electrically powered using the stored energy.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates, in a block diagram, a first embodiment of the measuring device according to the invention.

FIG. 2 schematically illustrates, in a block diagram, a second embodiment of the measuring device according to the invention.

FIG. 3 schematically illustrates an example of an electric machine according to an aspect of the invention.

FIG. 4 schematically illustrates an example of a battery according to an aspect of the invention.

FIG. 5 schematically illustrates an example of a battery pack according to an aspect of the invention.

FIG. 6 schematically illustrates an example of a fuel cell according to an aspect of the invention.

FIG. 7 schematically illustrates an embodiment of the method according to an aspect of the invention.

### DETAILED DESCRIPTION OF EXEMPLARY EMBODIMENTS

FIG. 1 is an example of a measuring device 1 according to an aspect of the invention. The device 1 is intended to be mounted in a motor vehicle.

The device 1 comprises a main module 10 and a remote module 20.

### Main Module 10

The main module 10 comprises a control stage 110 and a primary winding 125 which are electrically connected to each other.

The primary winding 125 is preferably a PCB winding or a wired winding.

The control stage 110 is configured to electrically power the primary winding 125 on the basis of an alternating current, for example supplied by an electrical power source via a cable connected to an electrical network (not shown).

Electrically powering the primary winding 125 allows said primary winding 125 to generate a variable magnetic field which is a function of said alternating supply current.

### Remote Module 20

The remote module 20 comprises a secondary winding 215, an external piezoelectric transceiver 218, an internal piezoelectric transceiver 228 and a sensitive element 230.

The remote module 20 may contain more than one sensitive element 230 for measuring a plurality of parameters. The measured parameter(s) may be, for example, air temperature, air pressure, degree of humidity, intensity of an electric current, a mechanical force (stress), a torque, etc.

The secondary winding 215 is immersed in the magnetic field generated by the primary winding 125 when a magnetic field is generated by the primary winding 125. The secondary winding 215 is preferably a PCB winding or a wired winding and is connected to the external piezoelectric transceiver 218 in a wired manner.

The secondary winding 215 is configured to generate an alternating electric current on the basis of variations in the magnetic field generated by the primary winding 125 and to transmit the electric current to the external piezoelectric transceiver 218 in order to electrically power it.

When it is electrically powered by the secondary winding 215, the external piezoelectric transceiver 218 is configured to transmit ultrasonic signals to the internal piezoelectric transceiver 228 and to receive ultrasonic signals transmitted by the internal piezoelectric transceiver 228.

The internal piezoelectric transceiver 228 is configured to transmit ultrasonic signals to the external piezoelectric transceiver 218 and to receive ultrasonic signals transmitted by the external piezoelectric transceiver 218.

The internal piezoelectric transceiver 228 is configured to collect energy from the ultrasonic signals received from the external piezoelectric transceiver 218, this electrically powering it, and to electrically power the sensitive element 230 using said energy.

The internal piezoelectric transceiver 228 and the sensitive element 230 are connected in a wired or wireless manner.

The internal piezoelectric transceiver 228 is configured to receive a measurement signal S generated by the sensitive element 230, to extract the at least one value of the measured parameter from said received measurement signal S and to command the transmission of ultrasonic signals containing the at least one extracted parameter value to the external piezoelectric transceiver 218.

The sensitive element 230 is configured to measure a parameter such as, for example, air temperature, air pressure, degree of humidity, intensity of an electric current, a mechanical force (stress), a torque, etc.

The sensitive element 230 is configured to generate a measurement signal S comprising at least one value of the measured parameter and to transmit said measurement signal S to the internal piezoelectric transceiver 228.

The external piezoelectric transceiver 218 is configured to generate and transmit an alternating current signal containing the at least one extracted measured value to the secondary winding 215.

The secondary winding 215 is configured to generate a magnetic field when said secondary winding 215 is powered by said alternating current signal, said magnetic field being detected by the primary winding 125.

The control stage 110 is configured to determine the at least one measured parameter value on the basis of variations in the magnetic field which are detected by the primary winding 125.

In one embodiment:
the control stage 110 is configured to generate a signal at at least one predetermined frequency and to deliver the generated signal to the primary winding 125, and
the internal piezoelectric transceiver 228 is configured to resonate at at least one predetermined frequency, preferably at two predetermined frequencies, for example 200 kHz and 2 MHz,
the external piezoelectric transceiver 218 is configured to resonate at said at least one predetermined frequency in order to optimize the transmission rate of the ultrasonic signals and the consumption of electric current.

In one embodiment, the internal piezoelectric transceiver 228 is configured to store energy from the ultrasonic signals received from the external piezoelectric transceiver 218. Preferably, the internal piezoelectric transceiver 228 is configured to electrically power the sensitive element 230 using the stored energy only when a predetermined energy storage threshold has been reached.

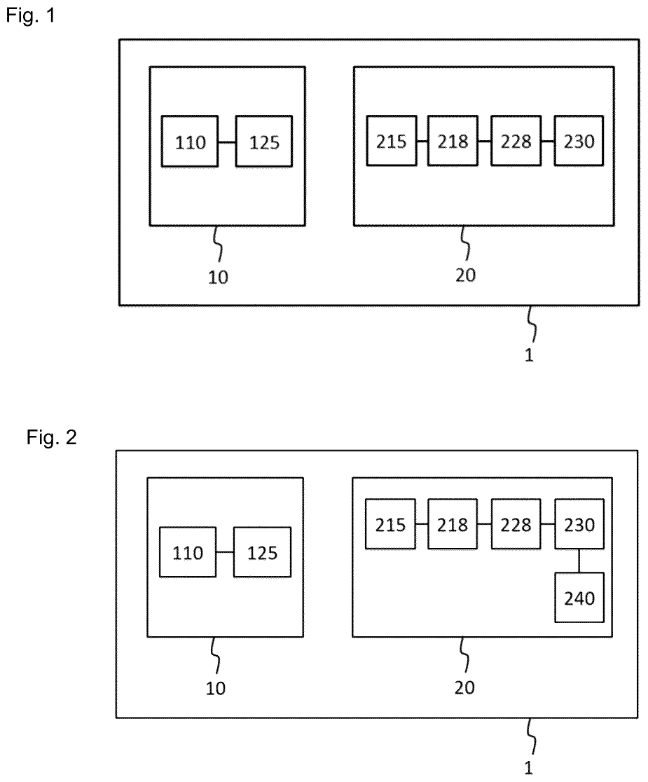

In one embodiment, illustrated in FIG. 2, the remote module 20 comprises an external communication stage 240 configured to transmit signals containing the at least one measured value. This transmission may, for example, be carried out on a communication interface of Bluetooth type or of RFID type, which are known per se. In this case, the external communication stage 240 preferably comprises a microcontroller allowing this transmission function to be implemented.

### Examples of Use of the Measuring Device According to Aspects of the Invention

### Example 1: Electric Machine 300

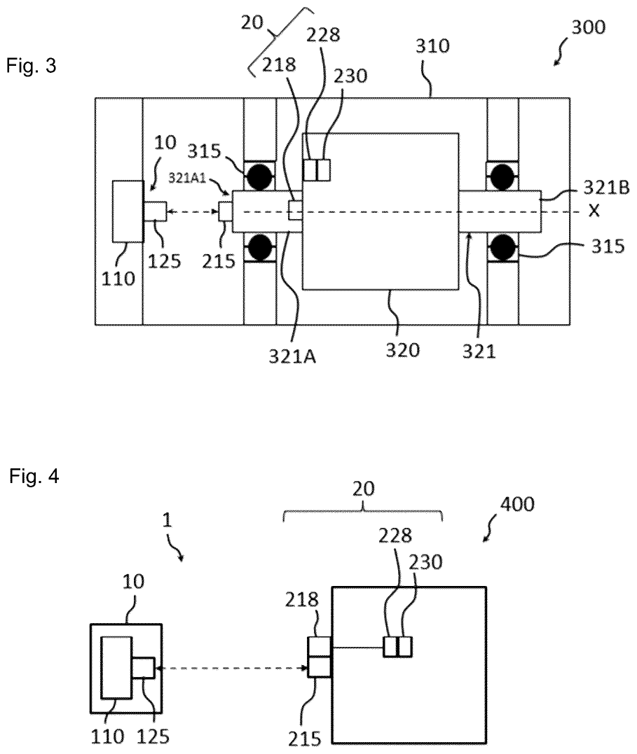

FIG. 3 is an example of an electric machine 300 for a motor vehicle. The electric machine 300 is configured to be mounted in the vehicle in order to drive the wheels of said vehicle in rotation.

The electric machine 300 comprises a stator 310, a rotor 320, and a device 1 as described above.

The main module 10 is mounted on the stator 310 and the remote module 20 is mounted on the rotor 320.

The rotor 320 is configured to rotate about a longitudinal axis X.

In this example, the rotor 320 comprises an integral shaft 321 extending along the longitudinal axis X of rotation and containing a first shaft portion 321A and a second shaft portion 321B which are connected to the stator 310 via a system of bearings 315.

The first shaft portion 321A comprises an end face 321A1 extending orthogonally to the longitudinal axis X of rotation of the rotor 320. The secondary winding 215 is mounted on said end face 321A1 and the external piezoelectric transceiver 218 is mounted on the first shaft portion 321A. The internal piezoelectric transceiver 228 is mounted inside the rotor 320. The primary winding 125 is mounted on a portion of the stator 310 facing the secondary winding 215.

### Example 2: Battery 400

FIG. 4 is an example of a battery 400 for a motor vehicle.

The main module 10 is placed at a distance from the battery 400 while the remote module 20 is mounted on the battery 400: the secondary winding 215 and the external piezoelectric transceiver 218 being on the outside and the internal piezoelectric transceiver 228 and the sensitive element 230 being placed inside the battery 400 in order to measure a parameter inside said battery 400, for example temperature or pressure, degree of humidity, intensity of an electric current, a mechanical force (stress), a torque, or other.

### Example 3: Battery Pack 500

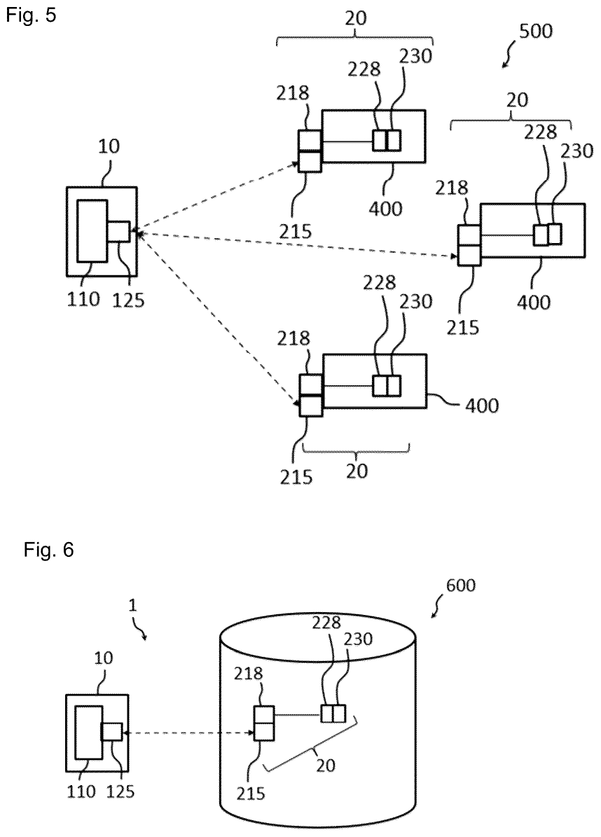

FIG. 5 is an example of a battery pack 500 for a motor vehicle.

The main module 10 is placed at a distance from the battery pack 500 while one or more remote modules 20 are respectively mounted on one or more of the batteries 400 of the battery pack 500 such that the sensitive element 230 of each remote module 20 measures a parameter inside of each battery 400 similarly to the preceding example, for example temperature or pressure.

### Example 4: Fuel Cell 600

FIG. 6 is an example of a fuel cell 600 for a motor vehicle.

The main module 10 is placed at a distance from the fuel cell 600 while the remote module 20 is mounted on the fuel cell 600 such that the sensitive element 230 measures a parameter inside said fuel cell 600, for example in the region of the circuit for supplying air to the membranes of the fuel cell 600, similarly to the preceding examples. Here again, the measured parameter(s) may for example be temperature, pressure, degree of humidity, intensity of an electric current, a mechanical force (stress) or a torque.

### Example of Implementation

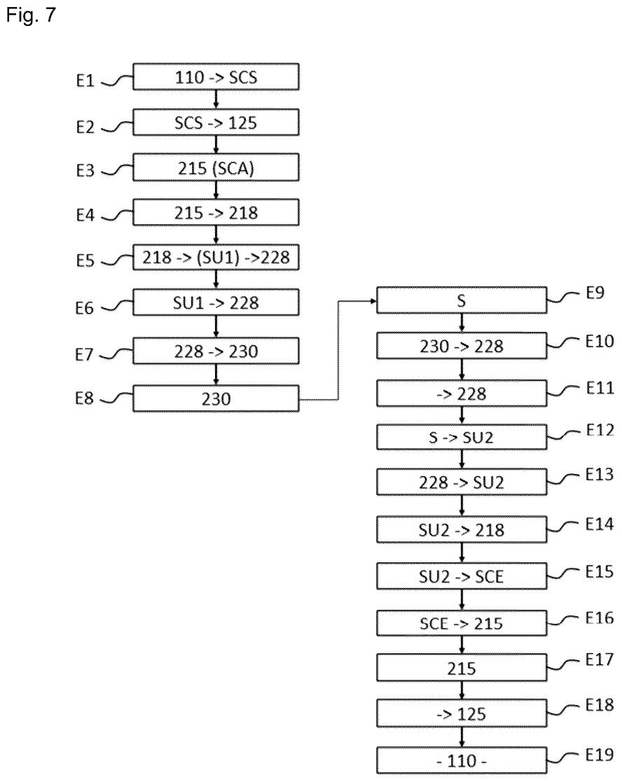

One example of implementation of the device 1 will now be described with reference to FIG. 7. In this non-limiting example, the parameter to be measured may for example be temperature, in particular inside a rotor 320 of an electric machine 300.

Firstly, in a step E1, when it is necessary to measure the parameter, the control stage 110 of the main module 10 electrically powers the primary winding 125 with an alternating electric source current SCS.

The primary winding 125 then generates, in a step E2, a magnetic field varying as a function of said alternating current.

As a result, the secondary winding 215 generates, in a step E3, an alternating electric supply current SCA on the basis of variations in the magnetic field generated by the primary winding 125 then transmits this electric supply current SCA to the external piezoelectric transceiver 218 in a step E4.

The external piezoelectric transceiver 218, powered by the electric supply current SCA received from the secondary winding 125, subsequently transmits an ultrasonic supply signal SU1 in a step E5.

This ultrasonic supply signal SU1 is received, in a step E6, by the internal piezoelectric transceiver 228 which converts the energy from the ultrasonic signal received into an electric current allowing the sensitive element 230 to be electrically powered in a step E7 such that said sensitive element 230 carries out at least one measurement of the parameter in a step E8.

Once the measurement has been carried out, the sensitive element 230 generates, in a step E9, a measurement signal S containing at least one value of the measured parameter then transmits this measurement signal S in a step E10 to the internal piezoelectric transceiver 228 which receives it in a step E11.

The internal piezoelectric transceiver 228 then converts the received measurement signal S into an ultrasonic measurement signal SU2 in a step E12 then transmits this ultrasonic measurement signal SU2 to the external piezoelectric transceiver 218 in a step E13.

The external piezoelectric transceiver 218 receives the ultrasonic measurement signal SU2 in a step E14 then converts the received ultrasonic measurement signal SU2 into an alternating excitation current signal SCE containing the at least one value of the measured parameter in a step E15.

The external piezoelectric transceiver 218 then uses this alternating excitation current signal SCE to power the secondary winding 215 in a step E16 so that said secondary winding 215 generates a magnetic field in a step E17.

The primary winding 125 then detects variations in the magnetic field generated by the secondary winding 215 in a step E18 while generating an output current representative of these variations, which it transmits to the control stage 110.

The control stage 110 then determines, in a step E19, the at least one measured parameter value on the basis of the variations detected by the primary winding 125, these variations being representative of the at least one measured parameter value contained in the alternating excitation current signal SCE powering the secondary winding 125.

The invention therefore makes it possible to measure a parameter with the aid of a remote module 20 powered at a distance with electrical energy, thus avoiding the use of a battery to be changed, this being particularly advantageous in the case of a rotor of an electric machine.

1. A device for measuring a parameter for a motor vehicle, said device comprising a main module and a remote module, said main module comprising a control stage and a primary winding, said control stage being configured to electrically power the primary winding on the basis of an alternating current so that said primary winding generates a variable magnetic field which is a function of said alternating current, said remote module comprising a secondary winding, immersed in said magnetic field when said magnetic field is generated, an external piezoelectric transceiver connected to said secondary winding in a wired manner and configured to transmit and receive ultrasonic signals, an internal piezoelectric transceiver configured to transmit and receive ultrasonic signals, and a sensitive element configured to measure said parameter, to generate a measurement signal comprising at least one value of the measured parameter and to transmit said measurement signal to said internal piezoelectric transceiver, said secondary winding being configured to generate an alternating electric current on the basis of variations in the magnetic field generated by the primary winding and to transmit said electric current to the external piezoelectric transceiver in order to electrically power it, the external piezoelectric transceiver being configured to, when it is electrically powered by the electric current received from the secondary winding, transmit ultrasonic signals to the internal piezoelectric transceiver, said internal piezoelectric transceiver being configured to collect energy from the ultrasonic signals received from the external piezoelectric transceiver, to electrically power the sensitive element using said energy, to receive a measurement signal generated by the sensitive element, to extract the at least one value of the measured parameter from said received measurement signal and to command the transmission of ultrasonic signals containing the at least one extracted parameter value to the external piezoelectric transceiver, the external piezoelectric transceiver being configured to generate and transmit an alternating current signal containing the at least one extracted measured value to the secondary winding, the secondary winding being configured to generate a magnetic field when said secondary winding is powered by said alternating current signal, said magnetic field being detected by the primary winding, the control stage being configured to determine the at least one measured parameter value on the basis of the variations in the magnetic field which are detected by the primary winding.

2. The device as claimed in claim 1, wherein the internal piezoelectric transceiver is configured to store the energy from the ultrasonic signals received from the external piezoelectric transceiver.

3. The device as claimed in claim 1, wherein the sensitive element and the internal piezoelectric transceiver are connected in a wired or wireless manner.

4. The device as claimed in claim 1, wherein the remote module comprises an external communication stage configured to transmit signals containing the at least one measured value.

5. The device as claimed in claim 1, wherein the external piezoelectric transceiver is configured to resonate at at least one predetermined frequency and the internal piezoelectric transceiver is configured to resonate at said at least one predetermined frequency.

6. An electric machine for a motor vehicle, said electric machine comprising a stator, a rotor and a device as claimed in claim 1, said electric machine being configured to be mounted in said vehicle in order to drive the wheels of said vehicle in rotation, an electric machine in which the main module is mounted on the stator and the remote module is mounted on the rotor.

7. The electric machine as claimed in claim 6, wherein the rotor comprises a shaft containing a first shaft portion and a second shaft portion which are mounted on the stator by a system of bearings, the first shaft portion containing an end face extending orthogonally to the longitudinal axis of rotation of the rotor, the secondary winding is mounted on said end face, the external piezoelectric transceiver is mounted on the first shaft portion, the internal piezoelectric transceiver and the sensitive element are mounted inside the rotor and the primary winding is mounted on a portion of the stator facing said secondary winding.

8. A battery pack for a motor vehicle, comprising a measuring device as claimed in claim 1, the remote module being mounted such that the sensitive element is respectively placed in at least one battery of the battery pack.

9. A motor vehicle comprising a measuring device as claimed in claim 1.

10. A method for measuring a parameter in a motor vehicle using a measuring device as claimed in claim 1, said method comprising the steps of:
electrical powering of the primary winding by the control stage with an alternating current,
generation by the primary winding, of a variable magnetic field which is a function of said alternating current,
generation, by the secondary winding, of an alternating electric supply current on the basis of variations in the magnetic field generated by the primary winding,
transmission of said electric supply current by the secondary winding to the external piezoelectric transceiver,
transmission, by the external piezoelectric transceiver, of an ultrasonic supply signal,
reception, by the internal piezoelectric transceiver, of the transmitted ultrasonic supply signal,
electrical powering of the sensitive element by the internal piezoelectric transceiver with an electric current generated on the basis of the received ultrasonic supply signal so that said sensitive element carries out at least one measurement of the parameter,
measurement of the parameter by the sensitive element,
generation of a measurement signal by the sensitive element, said measurement signal containing at least one value of the measured parameter,
transmission, by the sensitive element, of the measurement signal to the internal piezoelectric transceiver,
reception, by the internal piezoelectric transceiver, of the measurement signal generated by the sensitive element,
conversion of the received measurement signal into an ultrasonic measurement signal,
transmission, by the internal piezoelectric transceiver, of said ultrasonic measurement signal,
reception, by the external piezoelectric transceiver, of the transmitted ultrasonic measurement signal,
conversion of the received ultrasonic measurement signal into an alternating excitation current signal containing the at least one value of the measured parameter,
powering of the secondary winding by said excitation current signal,
generation of a magnetic field by the secondary winding on the basis of said excitation current signal,
detection, by the primary winding, of variations in the magnetic field generated by the secondary winding,
determination, by the control stage, of the at least one measured parameter value on the basis of the variations in the magnetic field which are detected by the primary winding.
